(19) United States
(12) Patent Application Publication
(10) Pub. No.: US 2016/0313828 A1
(43) Pub. Date: Oct. 27, 2016

(54) OPTICALLY TRANSPARENT CONDUCTIVE MATERIAL

(71) Applicant: MITSUBISHI PAPER MILLS LIMITED, Sumida-ku, Tokyo (JP)

(72) Inventor: Takenobu Yoshiki, Sumida-ku (JP)

(73) Assignee: MITSUBISHI PAPER MILLS LIMITED, Sumida-ku, Tokyo (JP)

(21) Appl. No.: 15/103,505

(22) PCT Filed: Jan. 8, 2015
(86) PCT No.: PCT/JP2015/050407

§ 371 Date: Jun. 10, 2016

(30) Foreign Application Priority Data
Jan. 16, 2014 (JP) 2014-005681

(51) Int. Cl. G06F 3/044; G06F 3/041

(52) U.S. Cl. CPC G06F 3/044; G06F 3/0412; G06F 2203/04103; G06F 2203/04104

(57) ABSTRACT

Provided is an optically transparent conductive material which has low visibility of the metal pattern (the difference between the sensor part and the dummy part is inconspicuous) and reduced occurrence of short circuit. The optically transparent conductive material has, on a base material, a sensor part and a dummy part each formed of a metal pattern, the metal pattern of the sensor part being formed of repeats of one or more unit graphics having any shape, the metal pattern of the dummy part being formed of repeats of a unit graphic having any shape and a line break, the repetition cycle of the sensor part and the repetition cycle of the dummy part being equal in a same direction, the shape of the unit graphic of the sensor part and the shape of the unit graphic of the dummy part not being congruent (excluding the cases where only the presence of a line break makes the unit graphic of the dummy part not congruent with the unit graphic of the sensor part).

### TECHNICAL FIELD

The present invention relates to an optically transparent conductive material used for touchscreens, organic EL materials, solar cells, etc., and, in particular, to an optically transparent conductive material preferably used for projected capacitive touchscreens.

### BACKGROUND ART

In electronic devices, such as personal digital assistants (PDAs), laptop computers, office automation equipment, medical equipment, and car navigation systems, touchscreens are widely used as their display screens that also serve as input means.

There are a variety of touchscreens that utilize different position detection technologies, such as optical, ultrasonic, surface capacitive, projected capacitive, and resistive technologies. A resistive touchscreen has a configuration in which an optically transparent conductive material and a glass plate with a transparent conductive layer are separated by spacers and face each other. A current is applied to the optically transparent conductive material and the voltage of the glass plate with a transparent conductive layer is measured. In contrast, a capacitive touchscreen has a basic configuration in which a touchsensor formed of an optically transparent electrode is an optically transparent conductive material having a transparent conductive layer provided on a base material and there are no movable parts. Capacitive touchscreens are used in various applications due to their high durability and high transmission. Further, a touchscreen utilizing projected capacitive technology allows simultaneous multipoint detection, and therefore is widely used for smartphones, tablet PCs, etc.

As an optically transparent conductive material used for touchscreens, those having an optically transparent conductive layer made of an ITO (indium tin oxide) film formed on a base material have been commonly used. However, since an ITO conductive film has high refractive index and high surface light reflectivity, the light transmittance of an optically transparent conductive material utilizing an ITO conductive film is unfavorably low. In addition, due to low flexibility, the ITO conductive film is prone to crack when bent, resulting in increased electric resistance of the optically transparent conductive material.

As an alternative to the optically transparent conductive material having an optically transparent conductive layer made of an ITO conductive film, an optically transparent conductive material obtained by a semi-additive method for forming a metal conductive pattern, the method comprising forming a thin catalyst layer on a base plate, forming a resist pattern on the catalyst layer, forming a laminated metal layer in an opening of the resist layer by plating, and finally removing the resist layer and the base metal protected by the resist layer, is suggested.

Also, in recent years, a method in which a silver halide diffusion transfer process is employed using a silver halide photosensitive material as a precursor to a conductive material has been proposed. Regarding this method, disclosed is a technology for forming a metal silver pattern on a conductive material precursor having a physical development nucleus layer and a silver halide emulsion layer in this order on a base material. In this technology, the precursor is subjected to exposure with use of a desired pattern and then to a reaction with a soluble silver halide forming agent and a reducing agent in an alkaline fluid. The patterning by the method can reproduce uniform line width. In addition, the metal silver pattern produced by this method is formed of developed silver (metal silver) substantially without any binder component, and due to the highest conductivity of silver among all metals, a thinner line with a higher conductivity can be achieved as compared with other methods. An additional advantage is that the metal silver film obtained by this method has a higher flexibility, i.e. a longer flexing life as compared with an ITO conductive film.

Generally, in a projected capacitive touchscreen, two optically transparent conductive materials on each of which a plurality of column electrodes as sensor parts are patterned in the same plane are joined together, and the two serve as a touch sensor. If such a touch sensor is formed of only a plurality of sensor parts, the sensor parts are conspicuous. In a common attempt to avoid this, a dummy part that is not electrically connected to the sensor part is arranged in a place other than the sensor part. While in operation, an operator of a touchscreen usually keeps staring at the display, and as a result tends to recognize the difference between the sensor part and the dummy part (the sensor part and the dummy part are highly visible). In particular, when the above projected capacitive touchscreen is produced with use of an optically transparent conductive material having a metal pattern as a sensor part, the problem of the high visibility of the sensor part and the dummy part prominently appears because the metal pattern itself has a problem of high visibility.

To address this problem, Patent Literature 1 discloses a method in which a grid-like metal pattern is divided by a slit to give sensor parts. In this method, for the purpose of reducing the visibility of the metal pattern, the slit width is in a range from 20 μm to the maximum dimension of the grid, and the slit is provided in such a manner that the slit does not pass through any intersection of the grid. However, even if the slit width is 20 μm, the outline of the sensor part is visually recognized. In addition, even if the slit does not pass through any intersection of the grid, the visibility of the metal pattern cannot be sufficiently reduced. Patent Literature 2 suggests a non-linear slit for a lower visibility than that of a linear slit, but this attempt also cannot sufficiently reduce the visibility of the metal pattern.

Also, in a projected capacitive touchscreen in which a dummy part is provided between sensor parts with use of a slit as described above, short circuit between the sensor parts can be caused by, for example, an incorporated foreign object . Such short circuit lowers the sensitivity (accuracy in position detection) of the touchscreen. Meanwhile, as described in, for example, Patent Literature 3, it is known to provide a dummy part formed of a metal pattern in which a unit graphic has one or more line breaks for the purpose of preventing the sensitivity from lowering. It is also known to provide a dummy part having a unit graphic which is congruent with the unit graphic of the sensor part and which has one or more line breaks for the purpose of lowering the visibility of the metal pattern. However, in the cases where a dummy part and a sensor part are formed in such a manner, the light transmittance of the dummy part having the line breaks will be higher than that of the sensor part. Therefore, sufficient reduction in the visibility of the metal pattern cannot be achieved.

In Patent Literature 4, the dummy part is formed of dots so that the sensor part and the dummy part have the same total light transmittance and as a result the same level of visibility. However, an operator staring the touchscreen inevitably recognizes the difference between the metal pattern and the dots, and therefore, sufficient reduction in the visibility of the metal pattern cannot be achieved.

### CITATION LIST

### Patent Literature

Patent Literature 1: JP 2006-344163 A
Patent Literature 2: JP 2011-59771 A
Patent Literature 3: WO 2013/094728
Patent Literature 4: JP 2011-253263 A

### SUMMARY OF INVENTION

### Technical Problem

An object of the present invention is to provide an optically transparent conductive material which has low visibility of the metal pattern (the difference between the sensor part and the dummy part is inconspicuous) and reduced occurrence of short circuit and therefore is suitable as an optically transparent electrode for capacitive touchscreens.

### Solution to Problem

The above object of the present invention will be basically achieved by an optically transparent conductive material having, on a base material, a sensor part and a dummy part each formed of a metal pattern, the metal pattern of the sensor part having repeats of one or more unit graphics of any shape, the metal pattern of the dummy part having repeats of a unit graphic having any shape and a line break, the repetition cycle of the sensor part and the repetition cycle of the dummy part being equal in the same direction, the shape of the unit graphic of the sensor part and the shape of the unit graphic of the dummy part not being congruent (excluding the cases where only the presence of a line break makes the unit graphic of the dummy part not congruent with the unit graphic of the sensor part).

The difference in the aperture ratio between the sensor part and the dummy part is preferably within +/−1%. It is preferable that the unit graphic of the dummy part has a shape obtained by parallel translation of each side of the unit graphic of the sensor part resulting in that there is no overlap between any sides. It is also preferable that the unit graphic of the dummy part has a shape obtained by dividing each side of the unit graphic of the sensor part into pieces of any length and translating the pieces so that there is no overlap between any sides. It is also preferable that the unit graphic of the dummy part has a shape obtained by rotating, in any direction, each side of the unit graphic of the sensor part around any point on the side so that there is no overlap between any sides. It is also preferable that the unit graphic of the dummy part has a shape obtained by arranging at least two kinds of equivalent unit graphics of the unit graphic of the sensor part so that there is no overlap between any sides of each equivalent unit graphic. It is also preferable that the unit graphic of the dummy part has a shape obtained by arranging a plurality of minimum repetition graphics of the metal pattern of the sensor part, the plurality of minimum repetition graphics not sharing any side with each other, so that the arranged graphics do not have any contact with each other.

### Advantageous Effects of Invention

The present invention provides an optically transparent conductive material which has low visibility of the metal pattern (the difference between the sensor part and the dummy part is inconspicuous) and reduced occurrence of short circuit.

### BRIEF DESCRIPTION OF DRAWINGS

FIG. 1 is a schematic view showing an example of the optically transparent conductive material of the present invention.

FIG. 2 is an enlarged view of the sensor part of the optically transparent conductive material shown in FIG. 1.

FIG. 3 is an enlarged view of the sensor part and the dummy part of the optically transparent conductive material shown in FIG. 1.

FIG. 4 shows further enlarged views of the sensor part 11 and the dummy part 12 of FIG. 3.

FIG. 5 is an enlarged view showing another example of the sensor part and the dummy part of the optically transparent conductive material shown in FIG. 1.

FIG. 6 shows enlarged views showing another example of the sensor part and the dummy part.

FIG. 7 shows schematic views illustrating preferred unit graphics of the dummy part of the present invention.

FIG. 8 shows an example of equivalent unit graphics of the metal pattern of the sensor part.

FIG. 9 is an enlarged view of the sensor part and the dummy part of an optically transparent conductive material. The dummy part is formed of equivalent unit graphics of the unit graphic of the sensor part.

FIG. 10 is an enlarged view showing another example of the sensor part and the dummy part.

FIG. 11 is an enlarged view of the sensor part and the dummy part used in a comparative example.

### DESCRIPTION OF EMBODIMENTS

Hereinafter, the present invention will be illustrated in detail with reference to drawings, but it is needless to say that the present invention is not limited to the embodiments described below and various alterations and modifications may be made without departing from the technical scope of the invention.

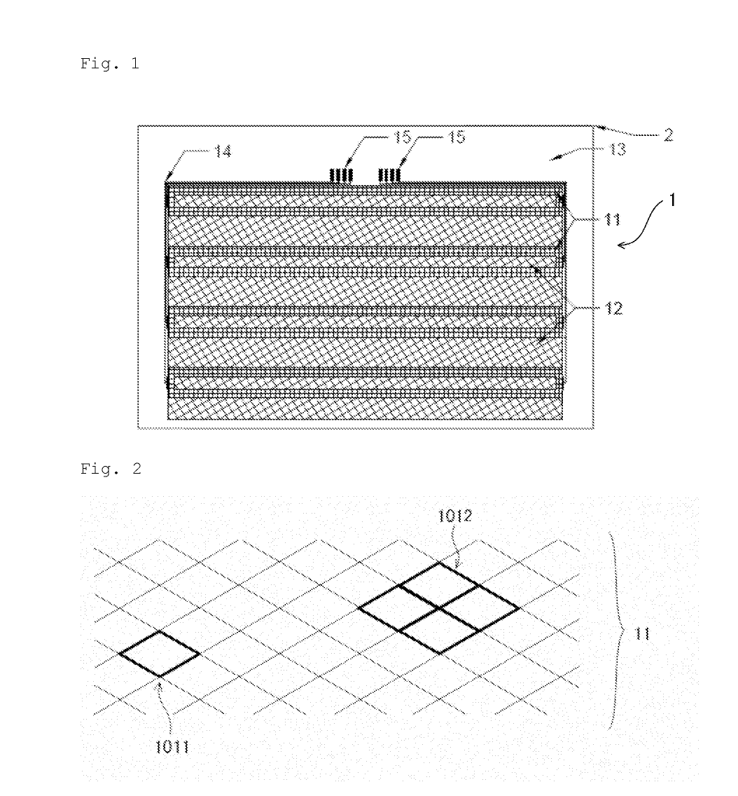

FIG. 1 is a schematic view showing an example of the optically transparent conductive material of the present invention. The optically transparent conductive material 1 of the present invention has, on a base material 2, at least a sensor part 11 formed of a metal pattern and a dummy part 12 also formed of a metal pattern. The sensor part 11 is electrically connected, via a wiring part 14, to a terminal part 15. By electrically connecting the terminal part 15 to the outside, the changes in capacitance detected by the sensor part 11 can be captured. In contrast, the dummy part 12 does not have electrical connection to the terminal part 15 via the wiring part 14. Such metal patterns, i.e., metal patterns not electrically connected to the terminal unit 15 are all called dummy parts in the present invention. In FIG. 1, the areas of the sensor part 11 and the dummy part 12 are shown in a checkered pattern for convenient illustration. The non-image part 13 does not have any metal pattern.

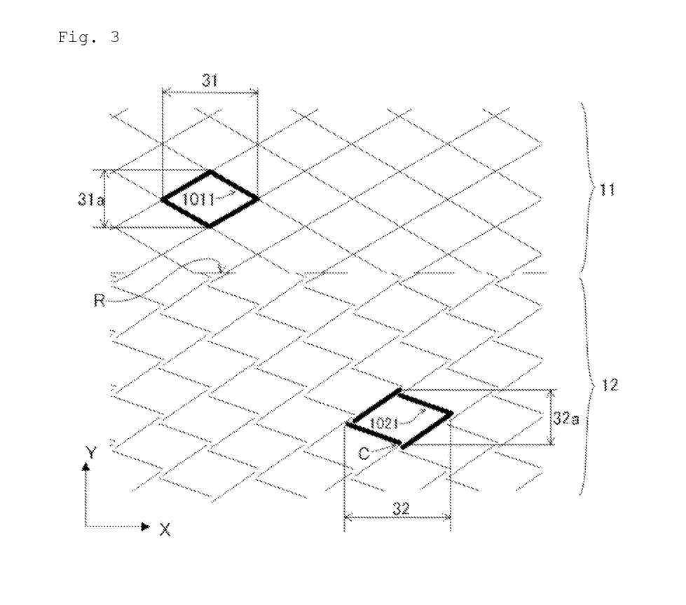

FIG. 2 is an enlarged view of the sensor part of the optically transparent conductive material shown in FIG. 1.

In the present invention, the “unit graphic” means a repetition unit of any shape which is repeatedly arranged to form a metal pattern. In FIG. 2, the sensor part 11 is formed by repeated arrangement of unit graphics 1011, which are shown in thick line for convenience (the same applies to subsequent figures) . From another perspective, the sensor part 11 in FIG. 2 is formed by repeated arrangement of unit graphics 1012 (shown in thick line), which is an assemblage of four unit graphics 1011.

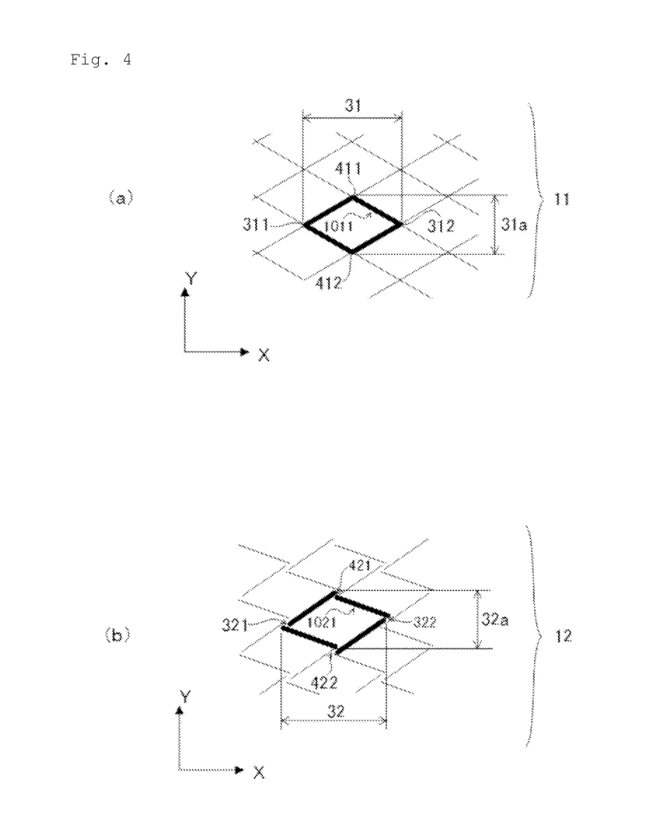

FIG. 3 is an enlarged view of the sensor part and the dummy part of the optically transparent conductive material shown in FIG. 1. In FIG. 3, the dummy part 12 and the sensor part 11 are electrically insulated by an imaginary boundary line R. The sensor part 11 in FIG. 3 is formed of periodically arranged unit graphics 1011 (shown in thick line), each of which is electrically connected to adjacent unit graphics thereof. Meanwhile, the dummy part 12 in FIG. 3 is formed of periodically arranged unit graphics 1021 (shown in thick line), each of which has line breaks C. The x-directional cycle length 31 of the unit graphic 1011 forming the sensor part 11 and the x-directional cycle length 32 of the unit graphic 1021 forming the dummy part 12 are equal, and also the y-directional cycle length 31a of the unit graphic 1011 forming the sensor part 11 and the y-directional cycle length 32a of the unit graphic 1021 forming the dummy part 12 are equal. In this case, when the congruence of the shape of the unit graphic of the sensor part and the shape of the unit graphic of the dummy part is examined, the unit graphic of the dummy part to be compared with the unit graphic 1011 of the sensor part 11 will be the unit graphic 1021. Here, in FIG. 3, the shape of the unit graphic 1011 and the shape of the unit graphic 1021 are not congruent, and therefore, it can be said that FIG. 3 is an enlarged view of the sensor part and the dummy part of the optically transparent conductive material that satisfies the requirements of the present invention. “Congruent” means the relationship between two figures where one figure coincides precisely with the other after one or more times of translocation including translation, rotation, and reflection.

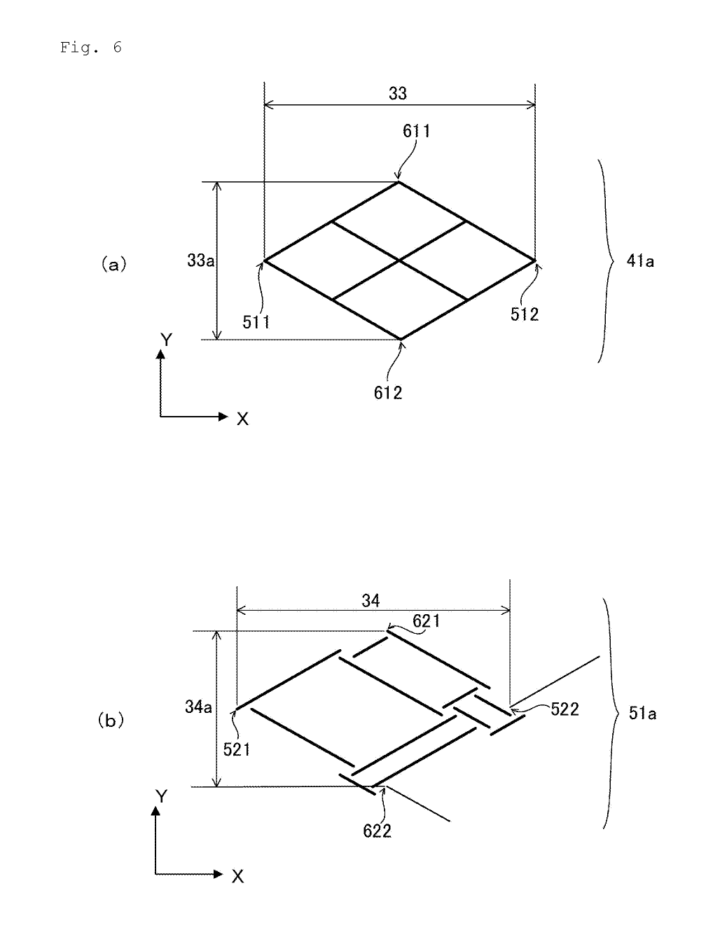

FIG. 5 is an enlarged view showing another example of the sensor part and the dummy part of the optically transparent conductive material shown in FIG. 1. In FIG. 5 also, a sensor part 11a and a dummy part 12a are electrically insulated by an imaginary boundary line R. The sensor part 11a in FIG. 5 is formed of unit graphics 41 (shown in thick line), each of which is an assemblage of four unit graphics A (shown in thick line) and is electrically connected to adjacent unit graphics thereof. Meanwhile, the dummy part 12a in FIG. 5 is formed of repeats of a unit graphic 51 (shown in thick line), which has line breaks C. The x-directional cycle length 31b of the unit graphic 41 forming the sensor part 11a and the x-directional cycle length 32b of the unit graphic 51 forming the dummy part 12a are equal, and also the y-directional cycle length 31c of the unit graphic 41 forming the sensor part 11a and the y-directional cycle length 32c of the unit graphic 51 forming the dummy part 12a are equal. In this case, when the congruence of the shape of the unit graphic of the sensor part and the shape of the unit graphic of the dummy part is examined, the unit graphic of the dummy part 12a to be compared with the unit graphic 41 of the sensor part 11a will be the unit graphic 51. Here, in FIG. 5, the shape of the unit graphic 41 and the shape of the unit graphic 51 are not congruent, and therefore, it can be said that FIG. 5 is an enlarged view of the sensor part and the dummy part of the optically transparent conductive material that satisfies the requirements of the present invention.

In FIG. 3, the sensor part 11 is formed of unit graphics 1011 (shown in thick line). In FIG. 5, the sensor part 11a is formed of unit graphics 41 (a unit graphic as an assemblage of four graphics A each having the same shape as that of the unit graphic 1011). Regardless of the difference in the constituting unit graphic, the shape of the sensor part 11 in FIG. 3 is the same as that of the sensor part 11a in FIG. 5. Meanwhile, the shape of the unit graphic of the dummy part 12 in FIG. 3 is different from that of the dummy part 12a in FIG. 5. Thus, in the present invention, even when the shapes of the metal patterns of the sensor parts indifferent embodiments are the same, the shapes of the unit graphics of the dummy parts can be different depending on the selection of the unit graphic of the sensor part (how the unit graphic is cut out) . This is clearly shown in FIG. 3 and FIG. 5.

In FIG. 2, the sensor part 11 has a metal pattern formed of lozenges, each of which is a unit graphic 1011 as a minimum repetition graphic. As the minimum repetition unit forming the metal pattern, other known shapes may be used, and examples thereof include triangles, such as an equilateral triangle, an isosceles triangle, and a right triangle; quadrangles, such as a square, a rectangle, a parallelogram, and a trapezoid; (equilateral) polygons, such as an (equilateral) hexagon, an (equilateral) octagon, an (equilateral) dodecagon, and an (equilateral) icosagon; a circle; an ellipse; and a star. Alternatively, a combination of two or more kinds of any shapes including these may be used. As described above, the unit graphic of the present invention may be a minimum repetition graphic or an assemblage of two or more minimum repetition graphics. Also, each side of the repetition graphic may be not a straight line but a zigzag line, a wavy line, etc. Also, the brick pattern as disclosed in JP 2002-223095 A may also be used. In the present invention, a metal pattern in which any of the above-mentioned shapes is repeatedly arranged may be used, but to avoid moire occurring in relation with a LCD display, the repetition graphic is preferably a square or a lozenge, preferably a lozenge having an angle of 30 to 70° between two sides. In the present invention, the interval between the lines of the repetition graphic is preferably 400 μm or less. The width of the lines is preferably 20 μm or less, more preferably 1 to 15 μm, and further more preferably 1 to 10 μm. In FIG. 2 and subsequent figures, solid lines are used for actually-existing metal patterns while dashed lines or the like are auxiliary lines used for the purpose of illustration and no real metal pattern exists there.

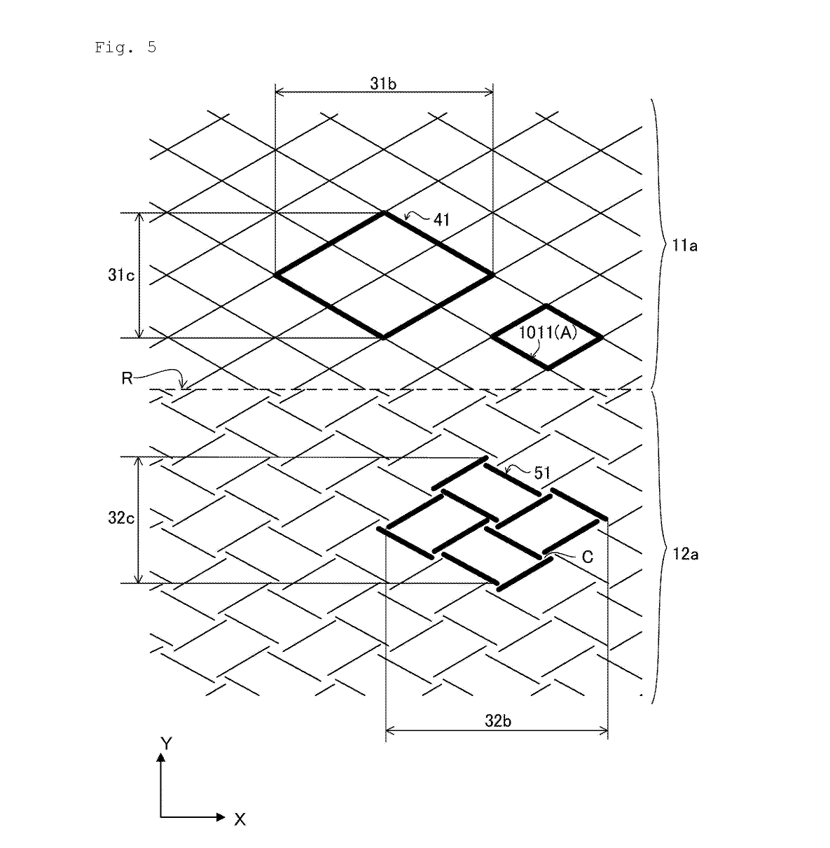

Next, the cycle of the unit graphic will be described. FIGS. 4(a) and (b) show further enlarged views of the sensor part 11 and the dummy part 12 of FIG. 3. In FIG. 4(a), the x-directional cycle length of the unit graphic 1011 of the sensor part is the distance from the vertex 311 of the unit graphic 1011 to the vertex 312 of the next unit graphic on the right, and is shown as the cycle length 31. Also, the y-directional cycle length is the distance from the vertex 411 of the unit graphic 1011 to the vertex 412 of the next unit graphic on the downside, and is shown as the cycle length 31a. Meanwhile, in FIG. 4(b), the x-directional cycle length of the unit graphic 1021 of the dummy part is the distance from the vertex 321 to the vertex 322 of the next unit graphic on the right, and is shown as the cycle length 32. Also, the y-directional cycle length is the distance from the vertex 421 of the unit graphic 1021 to the vertex 422 of the next unit graphic on the downside, and is shown as the cycle length 32a. Here, the cycle length 31 is equal to the cycle length 32, and the cycle length 31a is equal to the cycle length 32a. As described above, in the present invention, the repetition cycle of the unit graphic of the sensor part and the repetition cycle of the unit graphic of the dummy part are equal when compared in the same direction. In FIG. 3, for the comparison of the repetition cycle of the unit graphic of the sensor part and the repetition cycle of the unit graphic of the dummy part, the x direction and the y direction are taken for instance. However, the direction used for the comparison is not particularly limited, and any direction may be used. In the present invention, “the repetition cycles are equal” means that, when compared in the same direction, the ratio of the cycle length of the unit graphic of the sensor part to the cycle length of the unit graphic of the dummy part is in the range of 0.96 to 1.04, preferably 0.98 to 1.02.

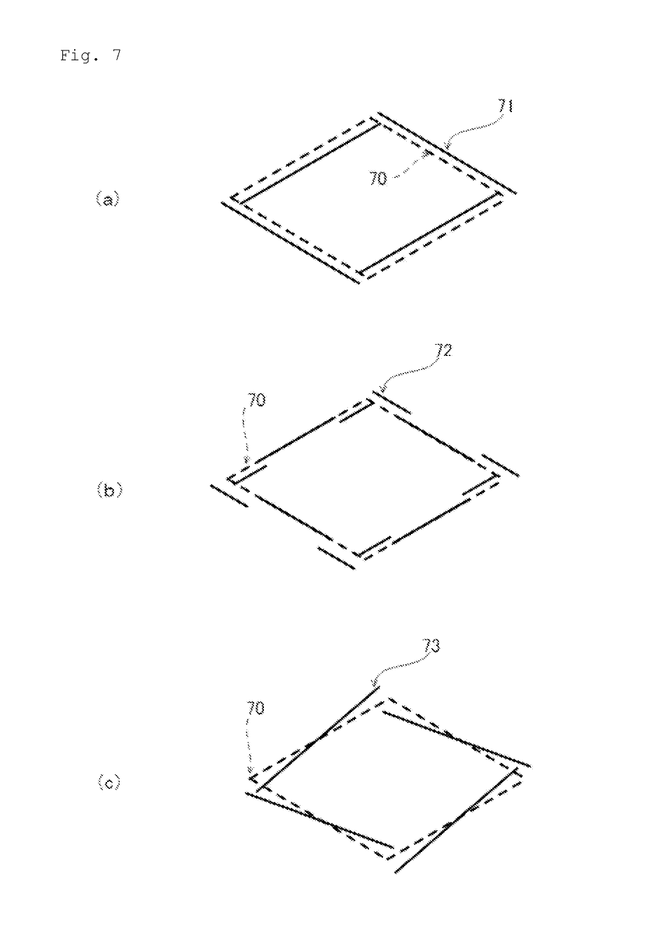

FIGS. 6(a) and (b) are enlarged views showing another example of the sensor part and the dummy part. In FIG. 6(a), the x-directional cycle length of a unit graphic 41a of the sensor part is the distance from the vertex 511 of the unit graphic 41a to the vertex 512 of the next unit graphic on the right, and is shown as the cycle length 33. Also, the y-directional cycle length is the distance from the vertex 611 of the unit graphic 41a to the vertex 612 of the next unit graphic on the downside, and is shown as the cycle length 33a. Meanwhile, in FIG. 6(b), the x-directional cycle length of a unit graphic 51a of the dummy part is the distance from the vertex 521 to the vertex 522 of the next unit graphic on the right, and is shown as the cycle length 34. Also, the y-directional cycle length is the distance from the vertex 621 of the unit graphic 51a to the vertex 622 of the next unit graphic on the downside, and is shown as the cycle length 34a. Here, the cycle length 33 is equal to the cycle length 34, and the cycle length 33a is equal to the cycle length 34a. In this example also, the repetition cycle of the sensor part and the repetition cycle of the dummy part are equal when compared in the same direction.

In the present invention, even when the shapes of the metal patterns of the sensor parts in different embodiments are the same, the shapes of the unit graphics of the dummy parts can be different depending on the selection of the unit graphic of the sensor part (how the unit graphic is cut out) . This is clearly shown by the relationship between FIG. 5 and FIG. 6, as with the relationship between FIG. 3 and FIG. 5 described above. The comparison of FIG. 5 with FIG. 6 shows that the shapes of the sensor parts are the same whereas the shapes of the dummy parts are different. In FIG. 6 again, for the comparison of the repetition cycle of the unit graphic of the sensor part and the repetition cycle of the unit graphic of the dummy part, the x direction and the y direction are taken for instance. However, the direction used for the comparison is not particularly limited, and any direction may be used.

In FIGS. 4(a) and (b), the unit graphic 1011 of the sensor part and the unit graphic 1021 of the dummy part are not congruent. In FIGS. 6(a) and (b) also, the unit graphic 41a of the sensor part and the unit graphic 51a of the dummy part are not congruent. Thus, in the present invention, when the unit graphic of the sensor part and the unit graphic of the dummy part are compared, these are not congruent. However, in the present invention, cases where only the presence of a line break makes the unit graphic of the dummy part not congruent with the unit graphic of the sensor part are excluded. In such cases, which are excluded from the present invention, connecting the broken lines makes the unit graphics congruent. In the above cases, due to the presence of the line break in the unit graphic of the dummy part, the light transmittance of the dummy part becomes higher than that of the sensor part, and as a result, sufficiently low visibility (a state where the difference between the sensor part and the dummy part is inconspicuous) cannot be achieved. In the present invention, the unit graphic of the sensor part and the unit graphic of the dummy part are not congruent, and the aperture ratio (the ratio of the area where no metal thin lines exist to the total area) of the dummy part is preferably within the range of +/−1% of the aperture ratio of the sensor part, more preferably within the range of +/−0.5%, and most preferably equal to the aperture ratio of the sensor part. Hereinafter, unit graphics of the dummy part that achieve the preferred range of the difference in aperture ratio between the sensor part and the dummy part (“the aperture ratio of the dummy part”-“the aperture ratio of the sensor part”) and achieve sufficiently low visibility (a state where the difference between the sensor part and the dummy part is inconspicuous) will be described.

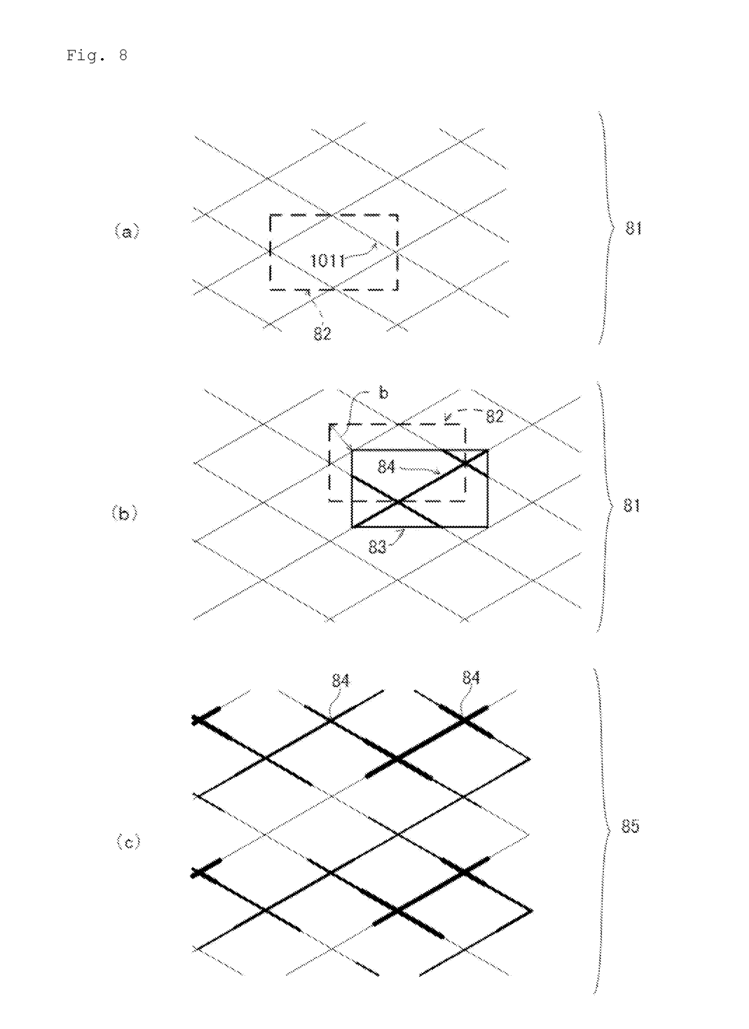

FIGS. 7(a), (b), and (c) show schematic views illustrating preferred unit graphics of the dummy part of the present invention. To achieve the difference in the aperture ratio between the sensor part and the dummy part being within +/−1%, the shape of the unit graphic of the dummy part is preferably any one of the following (1) to (3).
(1) The unit graphic of the dummy part has a shape obtained by parallel translation of each side of the unit graphic of the sensor part resulting in that there is no overlap between any sides.
(2) The unit graphic of the dummy part has a shape obtained by dividing each side of the unit graphic of the sensor part into pieces of any length and translating the pieces so that there is no overlap between any sides.
(3) The unit graphic of the dummy part has a shape obtained by rotating, in any direction, each side of the unit graphic of the sensor part around any point on the side so that there is no overlap between any sides.

FIG. 7(a) shows an example of the unit graphic of the dummy part, obtained by the method of the above (1). In FIG. 7(a), the shape of the unit graphic 70 of the sensor part is shown in dashed line for illustrative purposes. In FIG. 7(a), the unit graphic 71 of the dummy part is obtained by outwardly translating one pair of opposite sides of the unit graphic 70 of the sensor part and inwardly translating the other pair of opposite sides so that there is no overlap between any sides. The translation distance of each side is not particularly limited, but is preferably 150 to 1500%, more preferably 200 to 500% of the line width of the unit graphic 70 of the sensor part.

FIG. 7(b) shows an example of the unit graphic of the dummy part, obtained by the method of the above (2). In FIG. 7(b) also, the shape of the unit graphic 70 of the sensor part is shown in dashed line for illustrative purposes. In FIG. 7(b), the unit graphic 72 of the dummy part is obtained by dividing each side the unit graphic 70 of the sensor part into pieces of any length and translating the pieces outward or inward so that there is no overlap between any sides. The translation distance of each side is not particularly limited, but is preferably 150 to 1500%, more preferably 200 to 500% of the line width of the unit graphic 70 of the sensor part.

FIG. 7(c) shows an example of the unit graphic of the dummy part, obtained by the method of the above (3) . The center of the rotation is preferably the center of each side. In FIG. 7(c) also, the shape of the unit graphic 70 of the sensor part is shown in dashed line for illustrative purposes. In FIG. 7 (c) , the unit graphic 73 of the dummy part is obtained by rotating all the four sides of the unit graphic 70 of the sensor part to the left around the center of each side so that there is no overlap between any sides. The angle of rotation is preferably within the range of 1 to 30°, and more preferably within the range of 3 to 10°.

To achieve the difference in the aperture ratio between the dummy part and the sensor part being within +/−1%, it is also preferable that the unit graphic of the dummy part has the shape of the following (4).
(4) The unit graphic of the dummy part has a shape obtained by arranging at least two kinds of equivalent unit of the sensor part so that there is no overlap between any sides of each equivalent unit graphic.

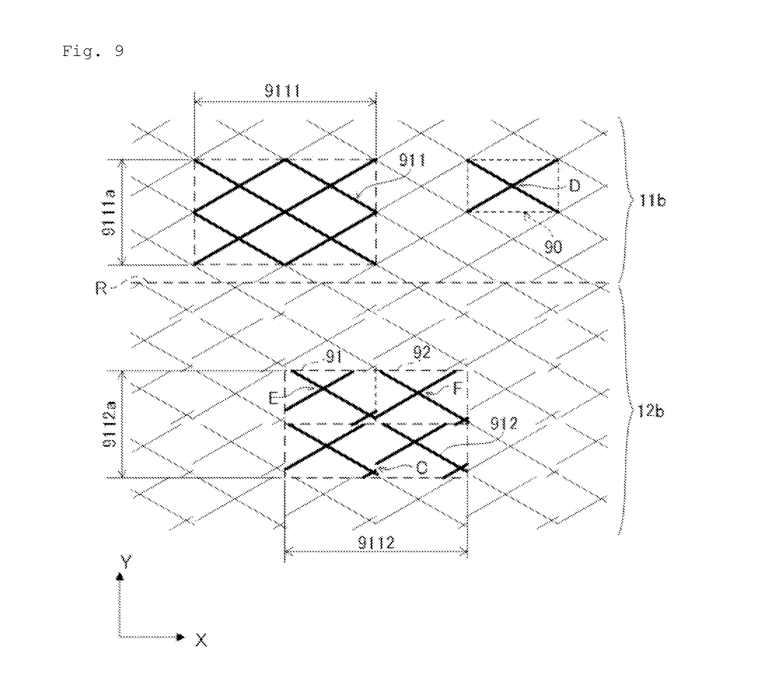

The above-mentioned equivalent unit graphics of the metal pattern of the sensor part will be described with reference to FIGS. 8(a), (b), and (c). FIGS. 8(a), (b), and (c) each show an example of equivalent unit graphics of the metal pattern of the sensor part.

In FIG. 8(a), the sensor part is formed of a grid-like pattern 81 formed of repeats of the unit graphic 1011. As shown in FIG. 8(a), the unit graphic 1011 exists in a unit graphic area 82 (shown in dashed line). Also, the grid-like pattern 81 shown in FIG. 8(a) can be formed of repeats of a unit graphic 84 (shown in thick line) which exists in a unit graphic area 83 (shown in solid line, which is not a real metal pattern but an imaginary line for illustrative purposes) as a result of translation of the dashed line 82 by the distance shown by the arrow b, as shown in FIG. 8(b). This is clearly shown in FIG. 8(c), where it is clearly shown that the grid-like pattern 85 is formed of repeats of the unit graphic 84 (in FIG. 8(c), four kinds of line thickness are used to illustrate the unit graphic 84).

Thus, the shape of the grid-like pattern 85 shown in FIG. 8(c) is the same as that of the grid-like pattern 81 shown in FIG. 8(a). Thus, in the present invention, “equivalent unit graphics” means two or more kinds of unit graphics having different shapes from each other but forming an identical grid-like pattern when repeatedly arranged. The unit graphic 84 is an equivalent unit graphic of the unit graphic 1011.

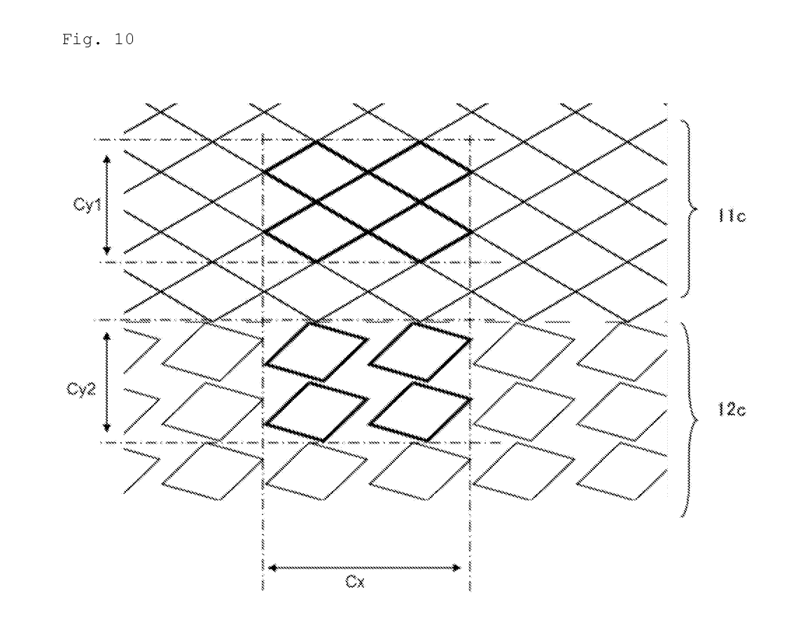

When the shape of the unit graphic of the dummy part is formed by repeating only one kind of equivalent unit graphic of the metal pattern of the sensor part so that there is no overlap between any sides, it is difficult to equalize the repetition cycle of the unit graphic of the sensor part and the repetition cycle of the unit graphic of the dummy part in the same direction. Therefore, it is necessary to form the shape of the unit graphic of the dummy part by arranging at least two kinds of equivalent unit graphics of the unit graphic of the sensor part so that there is no overlap between any sides of each equivalent unit graphic. FIG. 9 shows an example of such an arrangement. The sensor part 11b in FIG. 9 is formed of repeats of a unit graphic 911 (shown in thick line), which is an assemblage of four equivalent unit graphics D (one of which is shown in thick line in an area 90 (dashed line)) and is electrically connected to adjacent unit graphics thereof. Meanwhile, the dummy part 12b in FIG. 9 is formed of repeats of a unit graphic 912 (shown in thick line), which is an assemblage of two equivalent unit graphics E (one of which is enclosed in an area 91 (dashed line)) and two equivalent unit graphics F (one of which is enclosed in an area 92 (dashed line)), and has line breaks C. The x-directional cycle length 9111 of the unit graphic 911 forming the sensor part 11b and the x-directional cycle length 9112 of the unit graphic 912 forming the dummy part 12b are equal, and also the y-directional cycle length 9111a of the unit graphic 911 forming the sensor part 11b and the y-directional cycle length 9112a of the unit graphic 912 forming the dummy part 12b are equal. In this case, when the congruence of the shape of the unit graphic of the sensor part and the shape of the unit graphic of the dummy part is examined, the unit graphic of the dummy part 12b to be compared with the unit graphic 911 of the sensor part 11b will be the unit graphic 912. Here, in FIG. 9, the shape of the unit graphic 911 and the shape of the unit graphic 912 are not congruent, and therefore, it can be said that FIG. 9 is an enlarged view of the sensor part and the dummy part of the optically transparent conductive material that satisfies the requirements of the present invention.

The equivalent unit graphic shown in FIG. 8(b) is obtained by translation of the unit graphic area 82 preferably in a direction not in parallel with or perpendicular to but oblique to the direction in which the unit graphic is periodically arranged, and the translation distance is preferably 5 to 80 μm, more preferably 10 to 30 μm, and further more preferably 10 to 20 μm.

To achieve the difference in the aperture ratio between the dummy part and the sensor part being within +/−1%, it is also preferable that the unit graphic of the dummy part has the shape of the following (5).
(5) The unit graphic of the dummy part has a shape obtained by arranging a plurality of minimum repetition graphics of the metal pattern of the sensor part, the plurality of minimum repetition graphics not sharing any side with each other, so that the arranged graphics do not have any contact with each other.

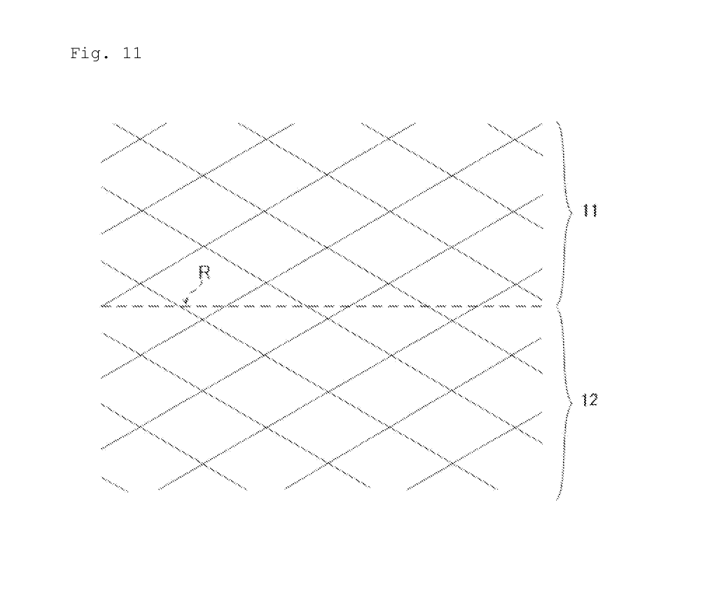

FIG. 10 shows an example of the unit graphic of the dummy part, obtained by the method of the above (5) . The unit graphic shown in thick line in the sensor part 11c has four lozenges as minimum repetition graphics not sharing any side with each other but having contact only at their vertexes. Each of the four lozenges is rotated to the left around its center of the mass so as to form a unit graphic of the dummy part 12c not having any contact between the lozenges. Since these four lozenges do not contact with each other, the gaps serve as line breaks in the unit graphic of the dummy part. The method for arranging the minimum repetition graphics in a manner to avoid the contact therebetween is not particularly limited, but it is preferred that each of the minimum repetition graphics is rotated around its center of the mass for example, to achieve such an arrangement. The x-directional cycle length Cx of the unit graphic forming the sensor part 11c and the x-directional cycle length Cx of the unit graphic forming the dummy part 12c are equal, and also the y-directional cycle length Cy1 of the unit graphic forming the sensor part 11c and the y-directional cycle length Cy2 of the unit graphic forming the dummy part 12c are equal. In this case, when the congruence of the shape of the unit graphic of the sensor part and the shape of the unit graphic of the dummy part is examined, the unit graphic of the dummy part to be compared with the unit graphic of the sensor part 11c will be the group of the four lozenges shown in thick line in the dummy part 12c in FIG. 10. Here, in FIG. 10, the shape of the unit graphic of the sensor part 11c and the shape of the unit graphic of the dummy part 12c are not congruent, and therefore, it can be said that FIG. 10 is an enlarged view of the sensor part and the dummy part of the optically transparent conductive material that satisfies the requirements of the present invention.

The line width of the unit graphic constituting the dummy part is preferably within the range of +/−2 μm based on the line width of the unit graphic constituting the sensor part, more preferably within the range of +/−1 μm, and further more preferably the same as the line width of the unit graphic constituting the sensor part.

Furthermore, in the present invention, the above-described unit graphics of the sensor part may have partial line breaks as long as the unit graphics are electrically connected with each other. However, the percentage of the total area of the unit graphics having such line breaks relative to the entire area of all the graphics is preferably 30% or less, more preferably 10% or less, and further more preferably 5% or less.

In the present invention, the grid-like pattern is preferably made of a metal, in particular, gold, silver, copper, nickel, aluminum, or a composite material thereof. As the method for forming the metal patterns, publicly known methods can be used, and the examples thereof include a method in which a silver halide photosensitive material is used; a method in which, after a silver image is obtained by the aforementioned method, electroless plating or electrolytic plating of the silver image is performed; a method in which screen printing with use of a conductive ink, such as a silver paste, is performed; a method in which inkjet printing with use of a conductive ink, such as a silver ink, is performed; a method in which a conductive layer made of a metal, such as copper, is formed by non-electrolytic plating etc.; a method in which a conductive layer is formed by evaporation coating or sputtering, a resist film is formed thereon, a pattern is formed on the resist film by exposure and development, etching of the conductive layer is performed, and the resist film is removed; and a method in which a metal foil, such as a copper foil, is placed, a resist film is formed thereon, a pattern is formed on the resist film by exposure and development, and etching of the metal foil is performed, and the resist film is removed. Among them, the silver halide diffusion transfer process is preferred for easily forming an extremely microscopic metal pattern and for producing a thinner metal pattern. If the metal pattern produced by any of the above-mentioned procedures is too thick, the subsequent processes may become difficult to carryout, and if the metal pattern is too thin, the conductivity required of touchscreens can hardly be achieved. Therefore, the thickness of the metal pattern is preferably 0.05 to 5 μm, and more preferably 0.1 to 1 μm.

As the base material used for the optically transparent conductive material of the present invention, plastics, glass, rubber, ceramics, etc. are preferably used. Preferred are base materials having a total light transmittance of 60% or more. Among plastics, flexible resin films are preferably used because of excellent ease in handling. Specific examples of the resin films used as the base material include resin films made of a polyester resin, such as polyethylene terephthalate (PET) and polyethylene naphthalate (PEN), an acrylate resin, an epoxy resin, a fluorine resin, a silicone resin, a polycarbonate resin, a diacetate resin, a triacetate resin, a polyarylate resin, a polyvinyl chloride, a polysulfone resin, a polyether sulfone resin, a polyimide resin, a polyamide resin, a polyolefin resin, a cyclic polyolefin resin, etc., the films having a thickness of 50 to 300 μm. The base material may be provided with a publicly known layer, such as an adhesion improving layer.

In the present invention, the optically transparent conductive material may be provided with, in addition to the base material and the grid-like pattern disposed thereon, a publicly known layer, such as a hard coating layer, an antireflection layer, an adhesive layer, an antiglare layer, etc. on the grid-like pattern (on the distant side from the base material) or on the base material (on the opposite side to the grid-like pattern). Between the base material and the grid-like pattern, a publicly known layer, such as a physical development nuclei layer, an adhesion improving layer, and an adhesive layer may be provided.

### EXAMPLES

Hereinafter, the present invention will be illustrated in more detail by Examples, but the present invention is not limited thereto unless it goes beyond the technical scope of the invention.

### Example 1

As a base material, a 100-μm-thick polyethylene terephthalate film was used. The total light transmittance of this base material was 91%.

Next, in accordance with the following formulation, a physical development nuclei coating liquid was prepared, applied onto the base material, and dried to provide a physical development nuclei layer.

| | | | |
|---|---|---|---|
| Liquid A | Palladium chloride | 5 | g |
| | Hydrochloric acid | 40 | mL |
| | Distilled water | 1000 | mL |
| Liquid B | Sodium sulfide | 8.6 | g |
| | Distilled water | 1000 | mL |

### <Preparation of Palladium Sulfide Sol>

Liquid A and Liquid B were mixed with stirring for 30 minutes, and then passed through a column filled up with an ion exchange resin to give a palladium sulfide sol.

### <Preparation of Physical Development Nuclei Coating Liquid>

| | | |
|---|---|---|
| The above-prepared palladium sulfide sol | 0.4 | mg |
| 2 mass % glyoxal aqueous solution | 0.2 | mL |
| Surfactant (S-1) | 4 | mg |
| Denacol EX-830 | 50 | mg |
| (Polyethylene glycol diglycidyl ether made by Nagase | | |
| Chemtex Corp.) | | |
| 10 mass % SP-200 aqueous solution | 0.5 | mg |
| (Polyethyleneimine made by Nippon Shokubai Co., | | |
| Ltd.; average molecular weight: 10,000) | | |

per m² of silver halide photosensitive material

Subsequently, an intermediate layer, a silver halide emulsion layer, and a protective layer, of which the compositions are shown below, were applied in this order (from closest to the base material) onto the above physical development nuclei layer, and dried to give a silver halide photosensitive material. The silver halide emulsion was produced by a general double jet mixing method for photographic silver halide emulsions. The silver halide emulsion was prepared using 95 mol % of silver chloride and 5 mol % of silver bromide so as to have an average particle diameter of 0.15 μm. The obtained silver halide emulsion was subjected to gold and sulfur sensitization using sodium thiosulfate and chloroauric acid by the usual method. The silver halide emulsion obtained in this way contained 0.5 g of gelatin per gram of silver.

### <Composition of Intermediate Layer per m² of Silver Halide Photosensitive Material>

| | | |
|---|---|---|
| Gelatin | 0.5 | g |
| Surfactant (S-1) | 5 | mg |
| Dye 1 | 5 | mg |

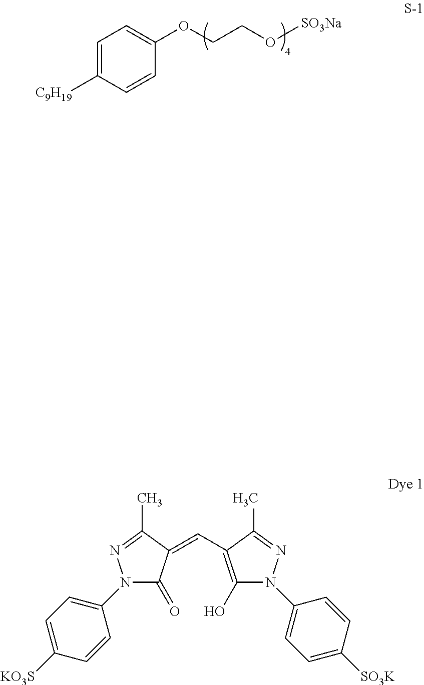

### <Composition of Silver Halide Emulsion Layer per m² of Silver Halide Photosensitive Material>

| Gelatin | 0.5 | g |
|---|---|---|
| Silver halide emulsion | Equivalent of | |
| | 3.0 g of silver | |
| 1-Phenyl-5-mercaptotetrazole | 3 | mg |
| Surfactant (S-1) | 20 | mg |

### <Composition of Protective Layer per m² of Silver Halide Photosensitive Material>

| | | |
|---|---|---|
| Gelatin | 1 | g |
| Amorphous silica matting agent | 10 | mg |
| (average particle diameter: 3.5 μm) | | |
| Surfactant (S-1) | 10 | mg |

The silver halide photosensitive material obtained as above was brought into close contact with a transparent manuscript having the pattern shown in FIG. 1, and exposure was performed, through a resin filter which cuts off light of 400 nm or less, using a contact printer having a mercury lamp as a light source. In the pattern of FIG. 1, the sensor part 11 is formed of repeats of a lozenge as a minimum repetition graphic, of which the line width is 7 μm, the length of each side is 300 μm, the smaller angle is 60°, and the shorter diagonal is 300 μm. This minimum repetition graphic is the unit graphic. The dummy part 12 is formed of periodically arranged unit graphics 1021 shown in FIG. 3, of which the line width is 7 μm. The unit graphic 1021 has a shape obtained by rotating each side of the unit graphic of the sensor part 8° to the left around the midpoint of the side. The repetition cycle of the sensor part and the repetition cycle of the dummy part are equal both in the x direction and in the y direction, and the difference in the aperture ratio between the sensor part and the dummy part is 0%.

Then, the silver halide photosensitive material subjected to exposure in close contact with a transparent manuscript having the pattern shown in FIG. 1 as described above was immersed in the diffusion transfer developer shown below at 20° C. for 60 seconds. Subsequently, the silver halide emulsion layer, the intermediate layer, and the protective layer were washed off with warm water at 40° C., and a drying process was performed. In this way, an optically transparent conductive material 1 having the silver pattern of FIG. 1 was obtained. The obtained optically transparent conductive material 1 had exactly the same line width and line interval as those of the transparent manuscript. The film thickness of the metal pattern measured with a confocal microscope was 0.1 μm.

### <Composition of Diffusion Transfer Developer>

| | | |
|---|---|---|
| Potassium hydroxide | 25 | g |
| Hydroquinone | 18 | g |
| 1-Phenyl-3-pyrazolidone | 2 | g |
| Potassium sulfite | 80 | g |
| N-methylethanolamine | 15 | g |
| Potassium bromide | 1.2 | g |

Water was added to the above ingredients to make the total volume of 1000 mL, and the pH was adjusted to 12.2.

### Example 2

The same procedure was performed as in Example 1 except for using the transparent manuscript described below to give an optically transparent conductive material 2.

### Transparent Manuscript:

The pattern is the same as that of FIG. 1. The sensor part 11 has the same shape as in Example 1 and the unit graphic is the unit graphic 41 shown in FIG. 5. The dummy part 12 is formed of periodically arranged unit graphics 51 shown in FIG. 5, and the shape of the unit graphic 51 is obtained by translating 10 each side of the unit graphic 41 of the sensor part 11 so that there is no overlap between any sides. The repetition cycle of the sensor part and the repetition cycle of the dummy part are equal both in the x direction and in the y direction, and the difference in the aperture ratio between the sensor part and the dummy part is 0%.

### Example 3

The same procedure was performed as in Example 1 except for using the transparent manuscript described below to give an optically transparent conductive material 3.

### Transparent Manuscript:

The pattern is the same as that of FIG. 1. The sensor part 11 has the same shape as in Example 1 and the unit graphic is the unit graphic 911 shown in FIG. 9. The unit graphic of the dummy part 12 is the unit graphic 912 shown in FIG. 9, which is obtained by arranging two each of at least two kinds of equivalent unit graphics of the unit graphic of the sensor part 11 so that there is no overlap between any sides of each equivalent unit graphic (where the first kind is enclosed in an area obtained by moving the area 82 of FIG. 8(a) 10 μm in a horizontal direction and 5 μm in a vertical direction (the translation distance is 11.18 μm) and the second kind is enclosed in an area obtained by moving the area 82 of FIG. 8(a) 15 μm in a horizontal direction and 10 μm in a vertical direction (the translation distance is 18 μm)). The repetition cycle of the sensor part and the repetition cycle of the dummy part are equal both in the x direction and in the y direction, and the difference in the aperture ratio between the sensor part and the dummy part is 0%.

### Example 4

The same procedure was performed as in Example 1 except for using the transparent manuscript described below to give an optically transparent conductive material 4.

### Transparent Manuscript:

The pattern is the same as that of FIG. 1. The sensor part 11c has the same shape as in Example 1 and the unit graphic is the one shown in FIG. 10. The dummy part 12c is formed of periodically arranged unit graphics each consisting of a group of four lozenges as shown in FIG. 10. The unit graphic has a shape obtained by rotating each of four lozenges as minimum repetition graphics of the sensor part 11 contacting with each other only at their vertexes 8° to the left around its center of the mass. The repetition cycle of the sensor part and the repetition cycle of the dummy part are equal both in the x direction and in the y direction, and the difference in the aperture ratio between the sensor part and the dummy part is 0%.

### Comparative Example 1

The same procedure was performed as in Example 1 except for using the transparent manuscript described below to give an optically transparent conductive material 5.

### Transparent Manuscript:

The pattern is the same as that of FIG. 1. The sensor part 11 and the dummy part 12 have the same shape as the sensor part in Example 1 and the boundary thereof is as shown in FIG. 11. In FIG. 11, the boundary between the sensor part 11 and the dummy part 12 has line breaks 10 μm in length on the imaginary boundary line R. Excluding the line breaks, the difference in the aperture ratio between the sensor part and the dummy part is 0%.

### Comparative Example 2

The same procedure was performed as in Example 1 except for using the transparent manuscript described below to give an optically transparent conductive material 6.

### Transparent Manuscript:

The pattern is the same as that of FIG. 1. The sensor part 11 has the same shape as in Example 1, and the dummy part 12 consists of a graphic having 39 randomly distributed dots of radius 2.05 μm per 10000 μm². The difference in the aperture ratio between the sensor part and the dummy part is 0%.

### Comparative Example 3

The same procedure was performed as in Example 1 except for using the transparent manuscript described below to give an optically transparent conductive material 7.

### Transparent Manuscript:

The pattern is the same as that of FIG. 1. The sensor part 11 has the same shape as in Example 1 and the dummy part 12 is formed of periodically arranged minimum repetition graphic which is the same as that of the sensor part 11. However, all the lozenges of the minimum repetition graphic of the dummy part 12 have a line break 20 μm in length at the midpoint of each side thereof. The difference in the aperture ratio between the sensor part and the dummy part (“aperture ratio of dummy part”-“aperture ratio of sensor part”) is +0.3%.

The optically transparent conductive material 7 is an example where the presence of a line break makes the unit graphic of the dummy part not congruent with the unit graphic of the sensor part.

The visibility and the reliability of the obtained optically transparent conductive materials 1 to 7 were evaluated. The evaluation results of the visibility and reliability are shown in Table 1. The visibility was evaluated as follows. The obtained optically transparent conductive material was put on a light table, and the boundary between the sensor part and the dummy part was examined. The level at which the boundary is obvious was defined as “1”, the level at which the boundary is noticeable from a distance of 50 cm was defined as “2”, the level at which the boundary is noticeable from a distance of about 20 cm was defined as “3”, and the level at which the boundary is unnoticeable from a distance of 20 cm was defined as “4”. The reliability was evaluated as follows. For each of the seven kinds of the optically transparent conductive materials, 100 sheets were produced. The presence or absence of short circuit in the pattern of FIG. 1 (between adjacent circuits each electrically connecting the terminal part 15, the wiring part 14, the sensor part, the wiring part 14, and the terminal part 15) was checked, and the number of sheets having short circuit was used as the evaluation value.

TABLE 1

| | | Reliability |
|---|---|---|
| | Visibility | (Number of sheets |
| | (Visibility level) | having short circuit |
| Example 1 | 4 | 0 |
| Example 2 | 4 | 1 |
| Example 3 | 4 | 3 |
| Example 4 | 4 | 1 |
| Comparative Example 1 | 1 | 5 |
| Comparative Example 2 | 2 | 3 |
| Comparative Example 3 | 3 | 3 |

Table 1 shows that in the cases of Examples 1 to 4 of the present invention, the visibility of the metal pattern is low (the difference between the sensor part and the dummy part is inconspicuous) and the number of sheets having short circuit is reduced as compared with Comparative Examples 1 to 3.

### REFERENCE SIGNS LIST

1 Optically transparent conductive material
2 Base material
11, 11a, 11b, 11c Sensor part
12, 12a, 12b, 12c Dummy part
13 Non-image part
14 Wiring part
15 Terminal part
31, 32, 33, 34, 31a, 32a, 31b, 32b, 31c, 32c, 33a, 34a, 9111, 9112, 9111a, 9112a, Cx, Cy1, Cy2 Cycle length
311, 312, 321, 322, 411, 412, 421, 422, 511, 512, 521, 522, 611, 612, 621, 622 Vertex
1011, 1012, 1021, 41, 41a, 51, 51a, 70, 71, 72, 73, 911, 912 Unit graphic
81, 85 Grid-like pattern
82, 83, 90, 91, 92 Area of unit graphic
R Imaginary boundary line
b Arrow
A Graphic
C Line break
D, E, F Equivalent unit graphic

1. An optically transparent conductive material having, on a base material, a sensor part and a dummy part each formed of a metal pattern, the metal pattern of the sensor part being formed of repeats of one or more unit graphics having any shape, the metal pattern of the dummy part being formed of repeats of a unit graphic having any shape and a line break, the repetition cycle of the sensor part and the repetition cycle of the dummy part being equal in a same direction, the shape of the unit graphic of the sensor part and the shape of the unit graphic of the dummy part not being congruent (excluding the cases where only the presence of a line break makes the unit graphic of the dummy part not congruent with the unit graphic of the sensor part).

2. The optically transparent conductive material of claim 1, wherein the difference in the aperture ratio between the sensor part and the dummy part is within +/−1%.

3. The optically transparent conductive material of claim 1, wherein the unit graphic of the dummy part has a shape obtained by parallel translation of each side of the unit graphic of the sensor part resulting in that there is no overlap between any sides.

4. The optically transparent conductive material of claim 1, wherein the unit graphic of the dummy part has a shape obtained by dividing each side of the unit graphic of the sensor part into pieces of any length and translating the pieces so that there is no overlap between any sides.

5. The optically transparent conductive material of claim 1, wherein the unit graphic of the dummy part has a shape obtained by rotating, in any direction, each side of the unit graphic of the sensor part around any point on the side so that there is no overlap between any sides.

6. The optically transparent conductive material of claim 1, wherein the unit graphic of the dummy part has a shape obtained by arranging at least two kinds of equivalent unit graphics of the unit graphic of the sensor part so that there is no overlap between any sides of each equivalent unit graphic.

7. The optically transparent conductive material of claim 1, wherein the unit graphic of the dummy part has a shape obtained by arranging a plurality of minimum repetition graphics of the metal pattern of the sensor part, the plurality of minimum repetition graphics not sharing any side with each other, so that the arranged graphics do not have any contact with each other.

8. The optically transparent conductive material of claim 2, wherein the unit graphic of the dummy part has a shape obtained by parallel translation of each side of the unit graphic of the sensor part resulting in that there is no overlap between any sides.

9. The optically transparent conductive material of claim 2, wherein the unit graphic of the dummy part has a shape obtained by dividing each side of the unit graphic of the sensor part into pieces of any length and translating the pieces so that there is no overlap between any sides.

10. The optically transparent conductive material of claim 2, wherein the unit graphic of the dummy part has a shape obtained by rotating, in any direction, each side of the unit graphic of the sensor part around any point on the side so that there is no overlap between any sides.

11. The optically transparent conductive material of claim 2, wherein the unit graphic of the dummy part has a shape obtained by arranging at least two kinds of equivalent unit graphics of the unit graphic of the sensor part so that there is no overlap between any sides of each equivalent unit graphic.

12. The optically transparent conductive material of claim 2, wherein the unit graphic of the dummy part has a shape obtained by arranging a plurality of minimum repetition graphics of the metal pattern of the sensor part, the plurality of minimum repetition graphics not sharing any side with each other, so that the arranged graphics do not have any contact with each other.
